(19) United States
(12) Patent Application Publication
(10) Pub. No.: US 2016/0134320 A1
(43) Pub. Date: May 12, 2016

(54) Night Stand Cell Phone Holder

(71) Applicant: Charles Schaar, Stanwood, WA (US)

(72) Inventor: Charles Schaar, Stanwood, WA (US)

(21) Appl. No.: 14/535,669

(22) Filed: Nov. 7, 2014

(51) Int. Cl. H04B 1/3827

(52) U.S. Cl. CPC H04B 1/3838

(57) ABSTRACT

A cue ball deflection path training aid used by beginning pool or billiards players to help them optimally position the cue ball for the next shot. The aid includes cue ball deflection grid attached or imprinted on a cue stick's top surface. The grid includes a main neutral line, a transverse line, and two diagonally aligned lines that converge to designate a center intersection point. The two diagonal lines are aligned at approximately 30 degrees from the transverse line. The grid is oriented on the cue stick so that the main neutral line is aligned with the cue stick's longitudinal axis. In one embodiment, the grid is printed on an adhesive label attached to or near the cue stick's midline axis. During use, the player holds the cue stick so that lines of the grid are aligned with the aiming line or over the object ball path line.

This utility patent application is based upon and claims the filing date benefit of U.S. utility patent application (Application No. 61/901,116) filed on Nov. 7, 2013.

Notice is given that the following patent document contains original material subject to copyright protection. The copyright owner has no objection to the facsimile or digital download reproduction of all or part of the patent document but otherwise reserves all copyrights.

### BACKGROUND OF THE INVENTION

1. Field of the Invention

This invention pertains to holders for a cell phone and more particularly to such holders that partially block electromagnetic radiation from the cell phone.

2. Description of the Related Art

While many scientists are concerned about the health effects of increased exposure to cellular telephone radiation in the microwave range, the health effects of long term exposure to cellular telephone radiation is uncertain. In 2000, the World Health Organization recommended the adoption of the “Precautionary Principle” regarding public cell phone usage. They recommend minimizing cell phone usage, limiting the use of cell phones by at-risk populations (children), and the adoption of cell phones and microcells that use low levels of radiation. In 2011, the International Agency for Research on Cancer (ICNIRP) classified mobile phone radiation as a possible “Group 2B” (carcinogenic). Longitudinal studies still underway will hopefully provide a definitive answer.

A cell phone is usually activated 24 hours per day and physically used by the owner approximately 120 minutes per day. Many owners carry their cell phones to bed and then place them on a nightstand next to the bed just before falling asleep. Sometimes owners will use their cell phones to listen to an audio file or an audio broadcast as they fall asleep. Because the display on a cell phone is illuminated, the cell phone is normally oriented face down on the mattress or under their pillow to block out light produced by the cell phone. This places the cell phone in close proximity to the owner's head or chest.

What is needed is a nightstand cell phone holder that partially blocks or shields microwave radiation and visible light emitted by the cell phone to the user lying in the bed next to the nightstand. The holder still allows cell phone communications signals to be sent and received by the cell phone when placed on the holder.

### SUMMARY OF THE INVENTION

Disclosed herein is a nightstand cell phone holder that partially blocks or shields EMF (such as microwave energy) and visible light transmitted by the cell phone to the user lying in the bed next to the nightstand. The holder includes a lower support surface configured to rest on a flat surface of the nightstand and receive and hold a cell phone. Integrally formed or attached to the lower support surface is an upper shielding surface configured to extend upward from the lower support surface and partially extend over the lower support surface and a cell phone positioned on the lower support surface. The holder is sufficiently wide to hold a cell phone in a portrait or landscape orientation. The holder is also made of EMF radiation absorbing or blocking material such as, aluminum or stainless steel. The material may be solid metallic material or mesh material with holes embedded in a thermoplastic substrate. During use, the holder is positioned on a flat surface, such as a nightstand, so the upper shielding surface extends upward from the lower support surface faces away from a user laying on the bed adjacent to the nightstand so that EMF (i.e. microwave energy) and visible light emitted from the cell phone in the direction towards the user are blocked.

### DESCRIPTION OF THE DRAWINGS

FIG. 1 is a front perspective view of one embodiment of the nightstand cell phone holder.

FIG. 2 is a side elevation view of the holder shown in FIG. 1.

FIG. 3 is a front elevational view of the holder shown in FIGS. 1 and 2.

FIG. 4 is a front perspective view of a second embodiment of the nightstand cell phone holder.

FIG. 5 is a side elevation view of the holder shown in FIG. 4.

FIG. 6 is a front elevational view of the holder shown in FIGS. 5 and 6.

FIG. 7 is a front perspective view of a third embodiment of the nightstand cell phone holder.

FIG. 8 is a side elevation view of the holder shown in FIG. 7.

FIG. 9 is a front elevational view of the holder shown in FIGS. 7 and 8.

FIG. 10 is a front perspective view of a fourth one embodiment of the nightstand cell phone holder.

FIG. 11 is a side elevation view of the holder shown in FIG. 10.

FIG. 12 is a front elevational view of the holder shown in FIGS. 10 and 11.

FIG. 13 is a front perspective view of a fifth embodiment of the nightstand cell phone holder.

FIG. 14 is a side elevation view of the holder shown in FIG. 13.

FIG. 15 is a front elevational view of the holder shown in FIGS. 13 and 14.

### DESCRIPTION OF THE PREFERRED EMBODIMENT(S)

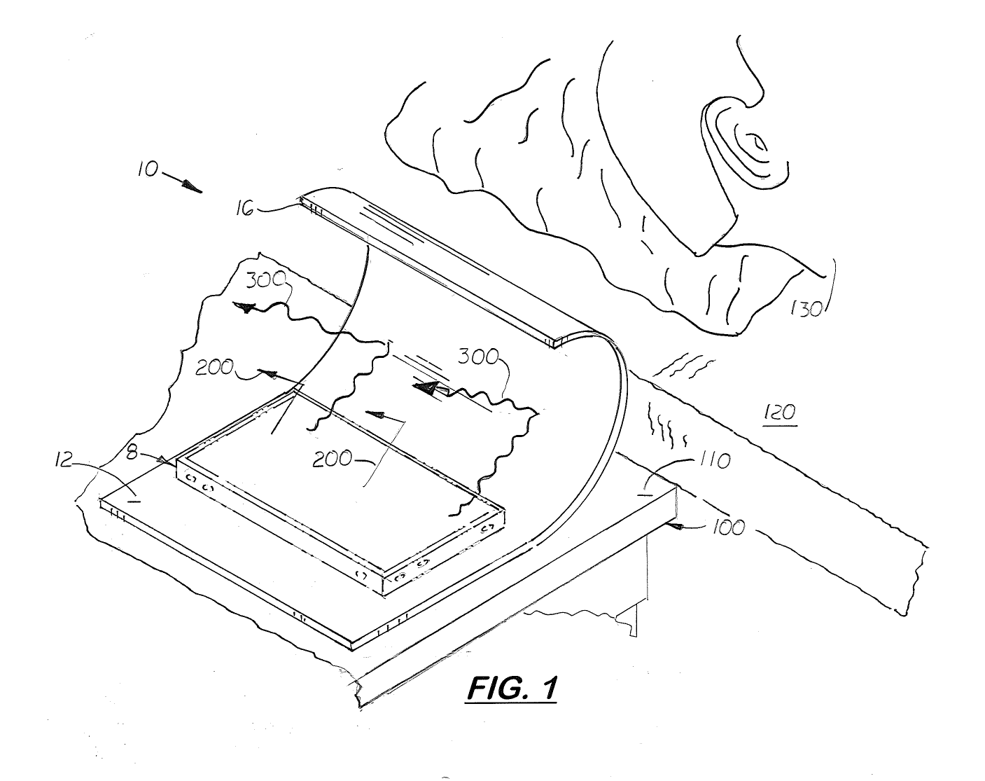

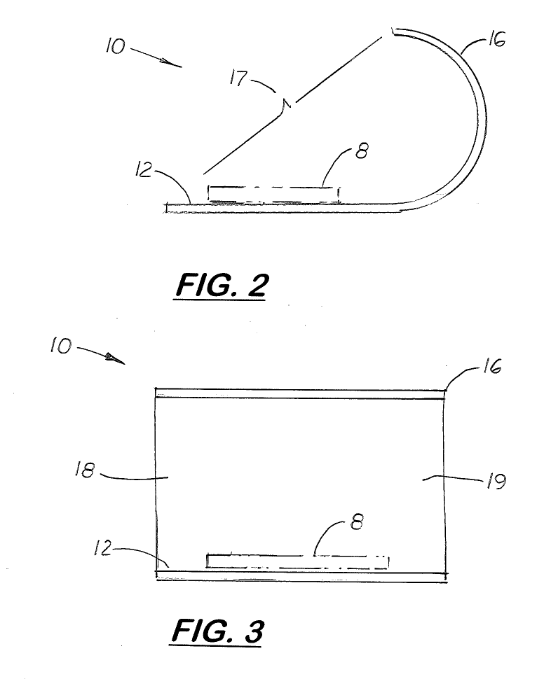

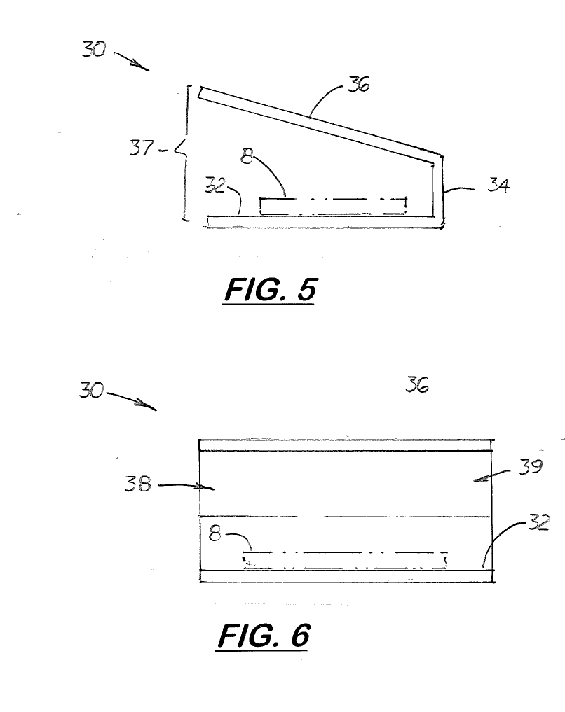

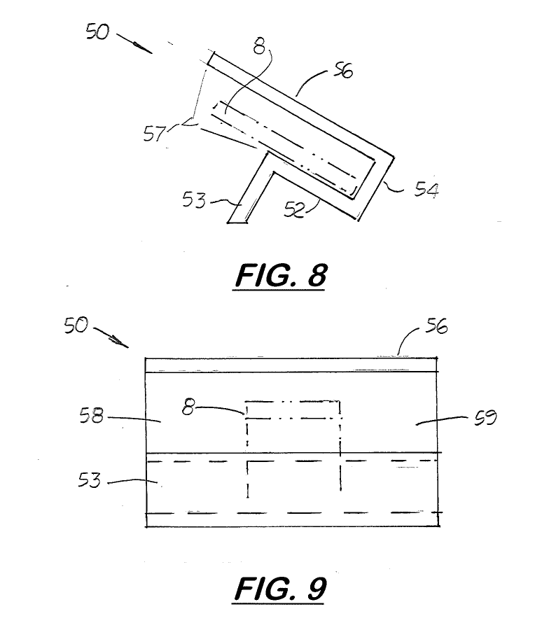

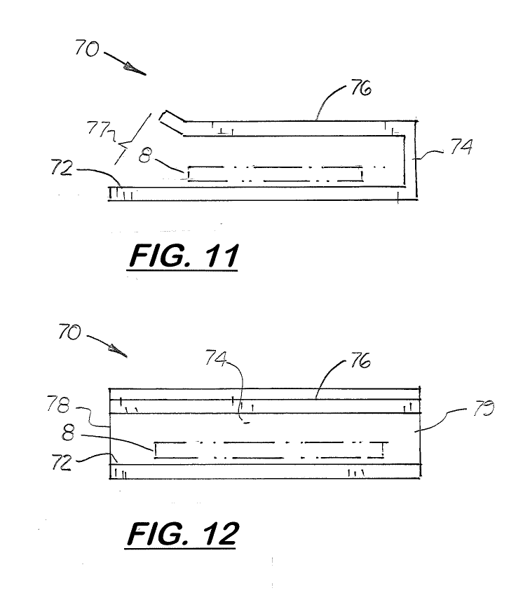

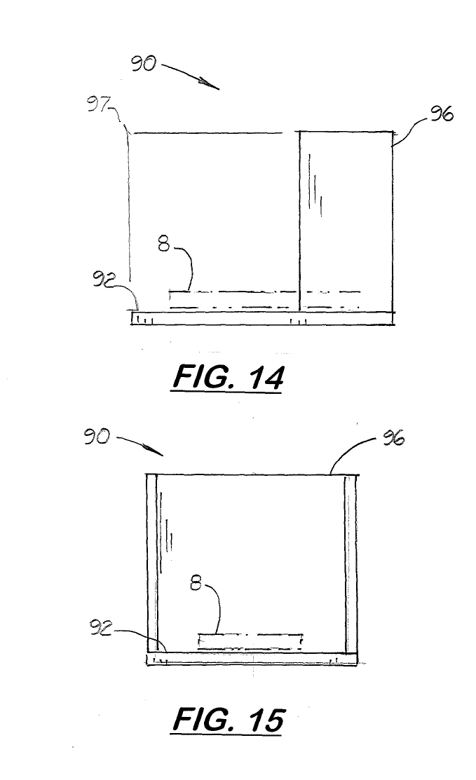

Shown in the accompanying FIGS. 1-15, are five embodiments of a cell phone holder 10, 30, 50, 70, and 90 configured to rest on a flat surface 110, such as the top surface of a nightstand 100, that partially blocks or shields microwave radiation or other forms of EMF radiation and visible light emitted from a cell phone 8 placed on the holder, 10, 30, 50, 70, and 90. More specifically, the holders 10, 30, 50, 70 and 90 are designed to block microwave energy and other forms of EMF radiation and light emitted laterally and upward from the cell phone 8. During normal use, the user 130 is lying on a bed 120 adjacent to the nightstand 100 as shown in FIG. 1.

Each embodiment of the holder 10, 30, 50, 70 and 90 holder includes a lower support surface 12, 32, 52, 72, and 92, respectively, configured to rest on a flat surface 110 on a nightstand, 100 and receives a cell phone 8. Attached or integrally formed on the lower support surface 12, 32, 52, 72, and 92 is an upper shield surface 16, 36, 56, 76, and 96, respectively, that extends upward from one end of the lower support surface 12, 32, 52, 72, and 92 respectively and extends over or around the cell phone 8. The upper shield surface 16, 36, 56, 76 and 96 partially extend over the lower support surface 12, 32, 52, 72, and 92 respectively, and over a cell phone 90 positioned on the lower support surface 12, 32, 52, 72 and 92. Each holder 10, 30, 50, 70 and 90 includes a lower support surface 12, 32, 52, 72, and 92, respectively that is sufficiently wide to hold a cell phone 8 in a portrait or landscape orientation. Each upper shield surface 16, 36, 56, 76, and 96 has a width approximately equal to the lower support surface 12, 32, 52, 72, and 92, respectively, to shield the user 130 from laterally transmitted EMF and light radiation from the cell phone 8.

The holder 10, 30, 50, 70 and 90 is also made of inexpensive EMF radiation absorbing or blocking material such as, aluminum or, stainless steel. The material may be a solid metallic material or made of thermoplastic material with embedded metallic mesh material. The mesh has a plurality of holes sufficient in size relative to the wavelength of the emitted radiation such that static and non-static electric fields are blocked.

As shown in FIG. 1, during use, the holder 10 is positioned on the nightstand 100 so the upper shielding surface 16 extends upward from the lower support surface 12 and extends in an opposite direction of the user 130. The area over the lower support surface 12 opposite the upper shielding surface 16 is uncovered, thereby forming a front opening enabling the cell phone 8 to send and receive signals from a nearby telecommunication network.

FIGS. 1-3 show a first embodiment of the holder 10 in which the upper support surface 16 curves upward and then inward over the lower support surface 12. Formed on the holder 10 is a front opening 17 and two side openings 18, 19.

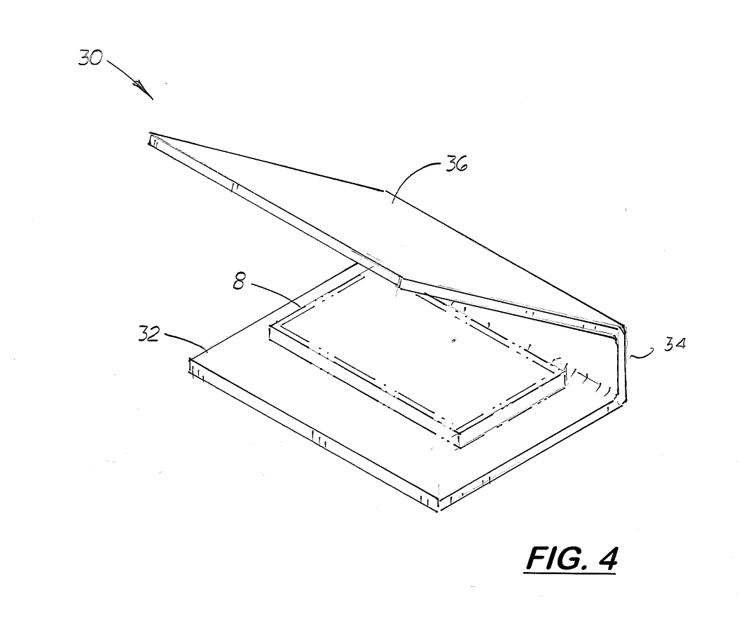

FIGS. 4-6 show a second embodiment of the holder 30 that includes a vertical rear wall 34 extends upward from the lower support surface 34, and a diagonally extending upper shield surface 56 from the vertical wall 34. Formed on the holder 30 is a front opening 37 and two side openings 38, 39.

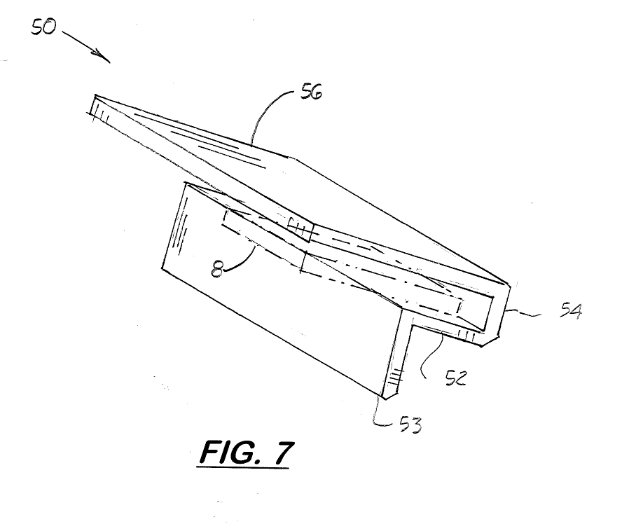

FIGS. 7-9 show a third embodiment of the holder 50 which includes an inverted V-shaped support surface that includes a lower leg member 53, a diagonal lower member 52, a rear diagonal member 34, and a diagonally aligned upper shield surface 56. The lower member 52 and upper shield surface 56 are spaced apart and parallel to form a diagonally aligned slot configured to receive the cell phone 8. Formed on the holder 50 is a front opening 57 and two side openings 58, 59.

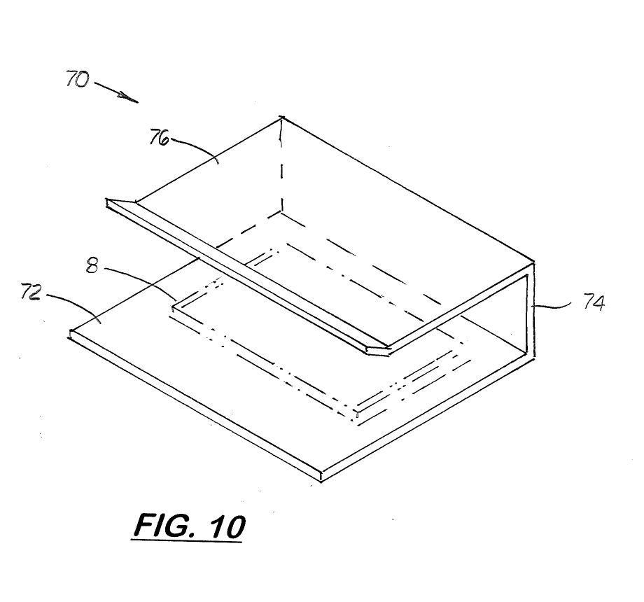

FIGS. 10-12 show a fourth embodiment of the holder 70 which the lower support surface 72 is a flat planar structure with a rear vertical member 74, and an upper shield surface 76. A horizontal slot is formed between the lower support surface 72 and the upper shield surface 76 in which a cell phone 8 is placed. Formed on the holder 70 is a front opening 77 and two side openings 78, 79.

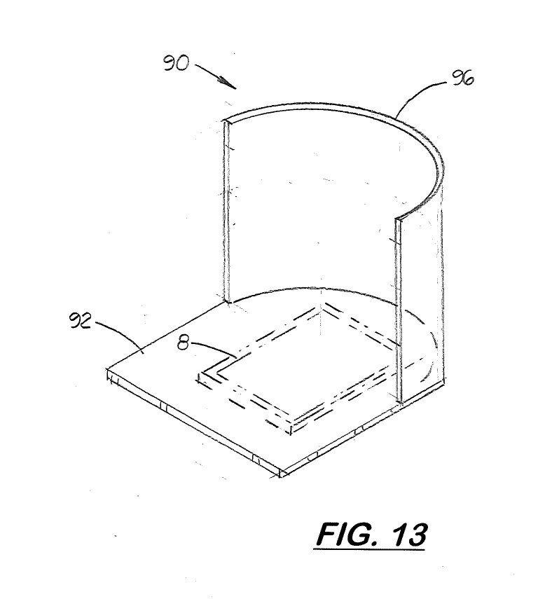

FIGS. 13-15 show a fifth embodiment of the holder 90 in which the lower support surface 92 is a flat planar structure and the upper shield surface 96 is a one-half cylindrical structure. Formed on the holder 90 is a front opening 97 and two side openings 98, 99.

In compliance with the statute, the invention described has been described in language more or less specific as to structural features. It should be understood however, that the invention is not limited to the specific features shown, since the means and construction shown, comprises the preferred embodiments for putting the invention into effect. The invention is therefore claimed in its forms or modifications within the legitimate and valid scope of the amended claims, appropriately interpreted under the doctrine of equivalents.

1. A cell phone holder that partially shields electro magnetic field radiation from a cell phone telephone when the cell phone is placed in the holder and the holder is placed on a horizontal surface, the holder comprising:
a. a flat lower support surface with a width and length configured to hold a cell phone deposited thereon in either a portrait or landscape orientation;
b. an upward extending rear wall integrally formed or attached to an edge of said lower support surface when said lower support surface is placed on a horizontal surface, said rear wall being the same width and made of solid or mesh electromagnetic field radiation absorbing or blocking material; and
c. a straight upper shield surface made of solid or mesh electromagnetic field radiation absorbing or blocking material integrally formed or attached to said rear wall, said upper shield surface being the same width as said lower support surface and extends diagonally upward from said rear wall and over said lower support surface and covers a cell phone deposited in either a portrait or landscape orientation on said lower support surface, said upper shield surface extends above said lower support surface and forms a front opening and two opposite side openings.

2. (canceled)

3. The cell phone holder, as recited in claim 1, wherein said upper shield surface is made of solid or mesh aluminum or stainless steel.

4. The cell phone holder, as recited in claim 1, wherein said lower support surface is a flat planar structure and said upper shield surface is a flat planar structure located above said lower support surface, said lower support surface and said upper shield surface are sufficiently spaced apart to form a slot with a front opening and two side openings and configured to receive a cell phone facing downward or upward on said lower support surface.

5. The cell phone holder, as recited in claim 4, wherein said upper shield surface is made of solid or mesh aluminum or stainless steel.

6. The cell phone holder, as recited in claim 1, wherein said lower support surface is an inverted V-shaped structure that includes a lower leg member, a diagonal lower member, a rear member, and a diagonally aligned upper shield member that is spaced apart and parallel to said diagonal lower member, said holder also includes a front opening and two side openings.

7. The cell phone holder, as recited in claim 6, wherein said upper shield surface is made of solid or mesh aluminum or stainless steel.

8. The cell phone holder, as recited in claim 1, wherein said lower support surface includes a flat horizontal planar structure with a rear vertical member, and said upper shield surface attached to said rear vertical member and extending over and parallel to said flat horizontal planar structure, said upper shield surface extends over said lower support surface and forms a slot configured to hold a downward facing or an upward facing cell phone, said slot includes a front opening and two side openings.

9. The cell phone holder, as recited in claim 8, wherein said upper shield surface is made of solid or mesh aluminum or stainless steel.

10. The cell phone holder, as recited in claim 1, wherein said lower support surface is a is a flat horizontal planar structure with said upper shield being a vertically aligned one-half cylindrical structure attached or formed on said lower support surface, said holder includes a front opening and two side openings.

11. The cell phone holder, as recited in claim 8, wherein said upper shield surface is made of solid or mesh aluminum or stainless steel.
